(19) United States
(12) Patent Application Publication
(10) Pub. No.: US 2019/0283875 A1
(43) Pub. Date: Sep. 19, 2019

(54) METHOD FOR TRANSMITTING IMAGE, DEVICE, AND UNMANNED AERIAL VEHICLE

(71) Applicant: SZ DJI TECHNOLOGY CO., LTD., Shenzhen (CN)

(72) Inventors: Lei ZHU, Shenzhen (CN); Ning MA, Shenzhen (CN); Ming GONG, Shenzhen (CN)

(21) Appl. No.: 16/433,191

(22) Filed: Jun. 6, 2019

Related U.S. Application Data
(63) Continuation of application No. PCT/CN2016/108996, filed on Dec. 8, 2016.

(51) Int. Cl. B64C 39/02; H04N 7/18; H04N 19/124

(52) U.S. Cl. CPC B64C 39/024; H04N 7/185; B64C 2201/127; B64C 2201/146; H04N 19/124

(57) ABSTRACT

A method for transmitting images includes obtaining image data of an image frame. The method also includes encoding the image data of the image frame to obtain first encoded image data. The method also includes determining a transmission delay of the first encoded image data. The method further includes re-encoding the image data of the image frame to obtain second encoded image data in response to determining that the transmission delay of the first encoded image data is not within a predetermined range.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION

This application is a continuation application of International Application No. PCT/CN2016/108996, filed on Dec. 8, 2016, the entire contents of which are incorporated herein by reference.

### TECHNICAL FIELD

The present disclosure relates to the technology field of image processing and, more particularly, to a method for transmitting images, a device, and an unmanned aerial vehicle (“UAV”).

### BACKGROUND

The current image transmission technologies generally use the following processes: image data of an image frame are acquired at a transmitting terminal; the transmitting terminal encodes the image data of the image frame, and transmits the encoded image data of the image frame to a receiving terminal through a communication channel. The receiving terminal decodes the received encoded image data to obtain the decoded image data of the image frame. The transmitting terminal may acquire different scenes or images of objects at different times. Therefore, the data rate of the image frames may change in real time (e.g., a signal source may change in real time). In addition, the communication channel between the transmitting terminal and the receiving terminal may also change in real time due to the influence of factors such as the distance, relative positions, whether there is an obstacle, whether there is electro-magnetic interference between the transmitting terminal and the receiving terminal. The changes in the signal source and the communication channel may be independent from one another. Hence, the changes may be difficult to predict. The current technologies for encoding image data of an image frame (i.e., the encoding methods for data of each image frame) are relatively fixed, and are difficult to adapt to the real-time changing signal source and communication channel. The lack of efficient image encoding methods and image transmission methods may reduce the utility of certain image transmission devices.

### SUMMARY

In accordance with an aspect of the present disclosure, there is provided a method for transmitting images. The method includes obtaining image data of an image frame. The method also includes encoding the image data of the image frame to obtain first encoded image data. The method also includes determining a transmission delay of the first encoded image data. The method further includes re-encoding the image data of the image frame to obtain second encoded image data in response to determining that the transmission delay of the first encoded image data is not within a predetermined range.

In accordance with another aspect of the present disclosure, there is also provided a device for transmitting images. The device includes a memory configured to store executable instructions. The device also includes a processor configured to execute the instructions to obtain image data of an image frame. The processor is also configured to encode the image data of the image frame to obtain first encoded image data. The processor is also configured to determine a transmission delay of the first encoded image data. The processor is further configured to re-encode the image data of the image frame to obtain second encoded image data in response to determining that the transmission delay of the first encoded image data is not within a predetermined range.

The disclosed method of the present disclosure includes determining, based on actual conditions, whether a transmission delay of first encoded image data is within a predetermined range. Based on this determination, the disclosed method further includes determining whether to re-encode the image data of the same image frame. In other words, the present disclosure can adaptively determine whether to encode an image frame once or multiple times based on a result of a first encoding of the data of the image frame. The present disclosure overcomes advantages associated with the conventional technology, where data of an image frame are encoded only once, which may cause image transmission delay or reduce image quality during the transmission. As a result, the present disclosure can enhance the flexibility of the encoding methods for the data of the image at the frame level.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram of an unmanned flight system, according to an example embodiment.

FIG. 2 is a schematic illustration of changing of the signal source and the communication channel over time, according to an example embodiment.

FIG. 3 is a flow chart illustrating a method for image transmission, according to an example embodiment.

FIG. 4 is a schematic illustration of data rates for a first encoding and a second encoding, according to an example embodiment.

FIG. 5 is a schematic illustration of image quality corresponding to the first encoding and the second encoding of FIG. 4, according to an example embodiment.

FIG. 6 is a schematic illustration of data rates for a first encoding and a second encoding, according to another example embodiment.

FIG. 7 is a schematic illustration of image quality corresponding to the first encoding and the second encoding of FIG. 6, according to another example embodiment.

FIG. 8 is a flow chart illustrating a method for image transmission, according to another example embodiment.

FIG. 9 is a schematic diagram of a device for image transmission, according to an example embodiment.

FIG. 10 is a schematic diagram of a device for image transmission, according to another example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless.

When a first component is referred to as “disposed,” “located,” or “provided” on a second component, the first component may be directly disposed, located, or provided on the second component or may be indirectly disposed, located, or provided on the second component via an intermediate component. The term “on” does not necessarily mean that the first component is located higher than the second component. In some situations, the first component may be located higher than the second component. In some situations, the first component may be disposed, located, or provided on the second component, and located lower than the second component. In addition, when the first item is disposed, located, or provided “on” the second component, the term “on” does not necessarily imply that the first component is fixed to the second component. The connection between the first component and the second component may be any suitable form, such as secured connection (fixed connection) or movable contact.

When a first component is referred to as “disposed,” “located,” or “provided” in a second component, the first component may be partially or entirely disposed, located, or provided in, inside, or within the second component. When a first component is coupled, secured, fixed, or mounted “to” a second component, the first component may be is coupled, secured, fixed, or mounted to the second component from any suitable directions, such as from above the second component, from below the second component, from the left side of the second component, or from the right side of the second component.

The terms “perpendicular,” “horizontal,” “left,” “right,” “up,” “upward,” “upwardly,” “down,” “downward,” “downwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure.

In addition, the singular forms “a,” “an,” and “the” are intended to include the plural forms as well, unless the context indicates otherwise. And, the terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

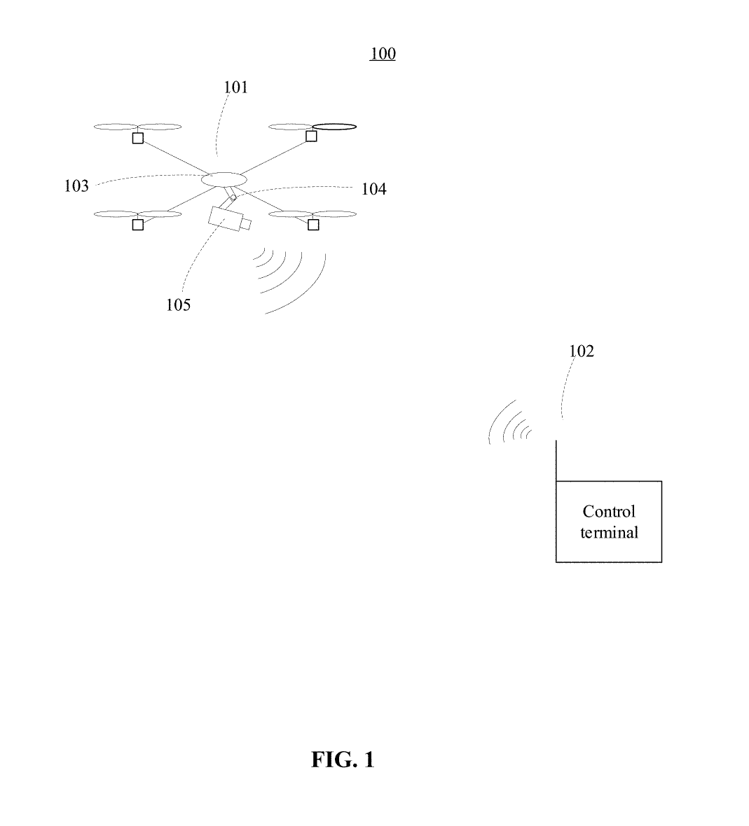

FIG. 1 is a schematic diagram of an unmanned flight system 100. The unmanned flight system 100 may include a UAV 101 and a control terminal 102. The UAV 101 may include a flying main body 103, a gimbal 104, and an imaging device 105. In some embodiments, the flying main body 103 may include multiple propellers and rotors for driving the multiple propellers to rotate, thereby providing a propulsion force for the flight of the UAV 101. The imaging device 105 may be carried by the flying main body 103 through the gimbal 104. The imaging device 105 may be configured to capture images or videos during the flight of the UAV 101. The imaging device 105 may include one or more of a multispectral imaging device, a hyperspectral imaging device, a visible light camera, or an infrared camera. The gimbal 104 may be a multi-axis transmission and stability-enhancement system. The gimbal 104 may include multiple rotating axes and a gimbal motor. The gimbal motor may compensate for the imaging angle of the imaging device by adjusting a rotation angle of one or more rotating axes. The gimbal 104 may be configured to eliminate or reduce the shaking of the imaging device 105 through suitable buffering or damping mechanisms.

The unmanned flight system 100 may include a control terminal 102. The control terminal 102 may communicate with the UAV 101 to exchange data with the UAV 101. For example, the data exchanged may include data or signals for controlling the flight of the UAV 101, and the data or signals for controlling the imaging device 105. In some embodiments, the communication between the control terminal 102 and the UAV 101 may be a wireless communication. In some embodiments, direct communication or indirect communication may be established between the UAV 101 and the control terminal 102.

The control terminal 102 may include, but not be limited to, a smart phone/cellular phone, a tablet, a personal digital assistant (“PDA”), a laptop, a desktop computer, a media player, a video game station/system, a virtual reality system, an augmented reality system, a wearable device, e.g., a watch, eye glasses, a glove, a head wearing device (e.g., a cap, a helmet, a virtual reality headset, an augmented reality headset, a head mount device (“HMD”), a head band, etc.

The imaging device 105 may acquire image data. The UAV 101 may be configured to encode the image data acquired by the imaging device 105 to obtain encoded image data. The encoded image data may be transmitted to the control terminal 102. The control terminal 102 may de-code the encoded image data and may display the de-coded image data on a display device or an interactive interface.

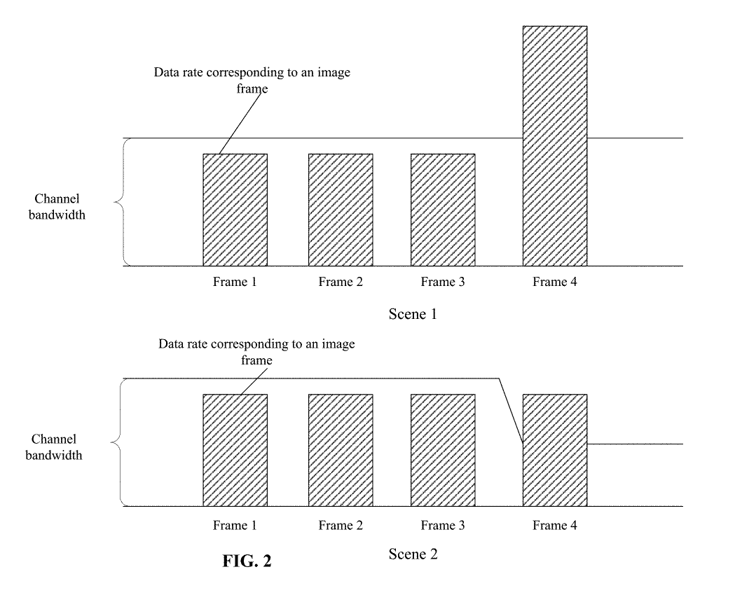

The stability of a transmission delay of the image data is an important factor for assessing the performance of an image transmission system. Maintaining stability of the transmission delay of the image data is a condition for producing smooth video images at a receiving terminal. However, during the transmission of the image data, signal source and communication channel may change in real time, which in turn may cause variations in the transmission delay between image frames. As a result, the performance of the image transmission system may be degraded. Next, using the change in the signal source and the change in the communication channel as examples, the issues of variations in the transmission delay for the image data at the frame level are discussed with reference to FIG. 2.

FIG. 2 shows Scene 1 and Scene 2. In Scene 1, the channel bandwidth of the communication channel between a transmitting terminal and a receiving terminal is maintained stable. During the transmission of image data using this communication channel, the camera at the transmitting terminal may move abruptly, or the object within the imaging range of the camera may move quickly and abruptly. For example, at one moment the imaging object of the camera is a blue sky, and at the next moment, the camera moves abruptly to capture images of colorful hot balloons flying in the sky. In such situations, the data rate corresponding to encoded frame 4 may be increased to be twice of the data rate corresponding to encoded frame 3. In such situations, the signal source changes abruptly. As a result, the transmission delay of frame 4 may be twice of the transmission delay of frame 3.

In Scene 2, the data rate corresponding to each image frame is maintained substantially stable. In other words, the signal source is stable. During the transmission of the image data, the channel bandwidth of the communication channel corresponding to frame 4 may abruptly reduce to be half of the channel bandwidth of the communication channel corresponding to frame 3. For example, when the imaging device of the UAV captures images of the imaging object, the imaging object may not change. However, during the flight, the UAV may abruptly move closer to a communication base station, which may affect the transmission channel of the UAV, thereby causing changes to the communication channel of the UAV. Similar to Scene 1, the transmission delay of frame 4 may increase to twice of the transmission delay of frame 3.

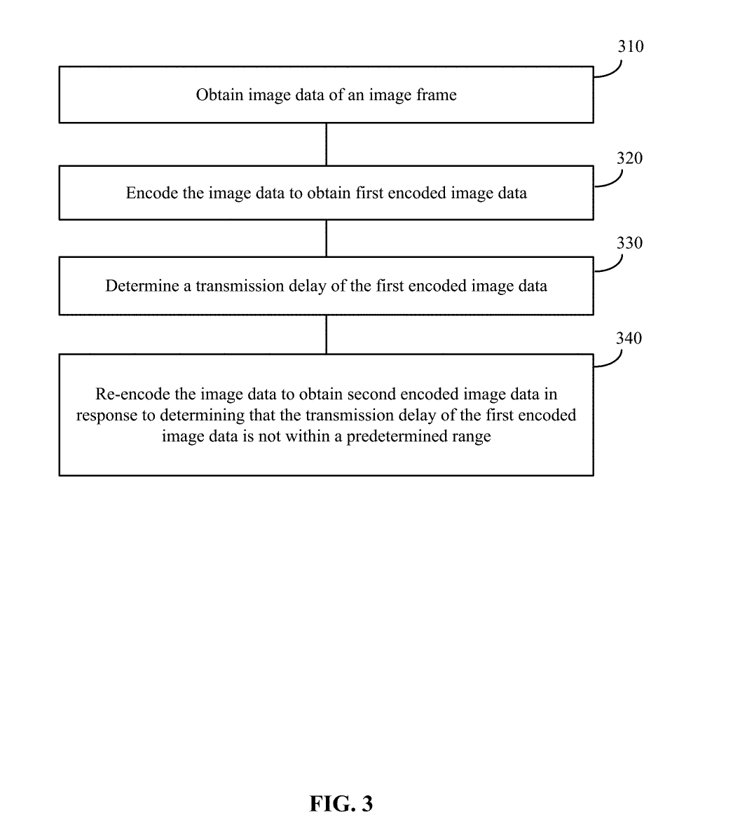

From the above descriptions of FIG. 2, it is understood that changes in the signal source changes and/or the communication channel (e.g., at least one of the signal source or the communication channel) may cause variations in the transmission delay of image data at the frame level. The changes in the signal source and the communication channel may be independent of one another, and may be difficult to predict. Current technologies for encoding the image data of each image frame are relatively fixed, which are difficult to adapt to the real time changing signal source and/or communication channel. The image transmission method of the present disclosure will be described below with reference to FIG. 3. The image transmission method of the present disclosure increases the flexibility of the encoding methods for the image data at the frame level. Therefore, the disclosed method can adapt to the real time changing signal source and/or communication channel.

FIG. 3 is a flow chart illustrating a method for image transmission. The method of FIG. 3 may include:

Step 310: obtaining image data of an image frame;

Step 320: encoding the image data to obtain first encoded image data;

Step 330: determining a transmission delay of the first encoded image data;

Step 340: re-encoding the image data to obtain second encoded image data in response to determining that the transmission delay of the first encoded image data is not within a predetermined range.

In some embodiments, when the imaging device captures images of the imaging object, the imaging device acquires or obtains image data of an image frame. The imaging device may be provided on the UAV. An encoding device of the UAV may encode the image data of the image frame to obtain first encoded image data. The encoding device may obtain a channel bandwidth of a present communication channel. The encoding device may determine a delay needed for transmitting the first encoded image data, i.e., the transmission delay of the first encoded image data, based on the data rate of the first encoded image data and the channel bandwidth of the present communication channel.

In some embodiments, after determining the transmission delay of the first encoded image data, the UAV may determine whether the transmission delay of the first encoded image data is within a predetermined range. When the transmission delay of the first encoded image data is not within the predetermined range, the UAV may re-encode the image data to obtain second encoded image data.

In some embodiments, when the transmission delay of the first encoded image data is not within the predetermined range, it may indicate that the signal source and/or the communication channel (or at least one of the signal source or the communication channel) may have changed, which may have caused changes in the data rate of the encoded image data and/or the channel bandwidth of the communication channel (e.g., at least one of the data rate or the channel bandwidth). For example, the imaging object of the imaging device may change abruptly, or the channel bandwidth of the communication channel may change abruptly. Under such conditions, the signal source and the communication channel are in a mismatch status. The transmission delay of the first encoded image data does not satisfy a requirement for the transmission delay, and the image data need to be re-encoded such that the transmission delay satisfies the requirement.

The disclosed method of the present disclosure includes determining, based on actual conditions, whether a transmission delay of first encoded image data is within a predetermined range. Based on this determination, the disclosed method further includes determining whether to re-encode the image data of the same image frame. In other words, the present disclosure can adaptively determine whether to encode an image frame once or multiple times based on a result of a first encoding of the image data of the image frame. The present disclosure increases the flexibility of the encoding methods of the image data at the frame level, and can effectively eliminate the situations where the image frame is encoded only once, and the transmission delay of the encoded image data of the image frame does not satisfy a specified requirement due to the abrupt change in the signal source and/or the communication channel. The present disclosure solves the adaptation issues associated with the signal source and/or the communication channel. The present disclosure may maintain the transmission delay of the encoded image data of each image frame to be within the predetermined range during the image transmission, thereby making the transmission delay satisfying the specified requirement. As a result, quality of image data encoding and quality of image transmission may be improved.

In some embodiments, the present disclosure does not limit the encoding method for the re-encoding. In some embodiments, step 320 may also include: encoding image data of an image frame based on a first quantization parameter. In some embodiments, step 340 may include: determining a second quantization parameter that is different from the first quantization parameter; and re-encoding the image data of the image frame based on the second quantization parameter. In other words, a first encoding and a second encoding (i.e., the re-encoding) of the image data may use different quantization parameters.

In some embodiments, after obtaining the image data of an image frame, the UAV may encode the image data of the image frame based on the first quantization parameter to obtain first encoded image data. When a transmission delay of the first encoded image data is not within a predetermined range, the UAV may determine whether the signal source and/or the communication channel has abruptly changed. The first encoded image data obtained based on encoding the image data of the image frame using the first quantization parameter may not satisfy a specified requirement on the transmission delay. The image data may need to be re-encoded. When performing the re-encoding, the UAV may determine a second quantization parameter that is different from the first quantization parameter, so as to adjust the encoding of the image data of the image frame. By adjusting the encoding, a transmission delay of the second encoded image data obtained through the re-encoding may be within the predetermined range.

In some embodiments, various methods may be used for selecting or determining the second quantization parameter. In some embodiments, multiple levels may be set for the quantization parameter. Quantization parameters at different levels may be different. When the image data need to be re-encoded, the quantization parameter may be raised by a level or reduced by a level based on the first quantization parameter to obtain the second quantization parameter.

In some embodiments, the UAV may determine an expected transmission delay for the second encoded image data, and then determine the second quantization parameter based on the expected transmission delay.

In some embodiments, various methods may be used to determine the second quantization parameter based on the expected transmission delay. For example, encoding the image data of an image frame may obtain first encoded image data. The data rate of the first encoded image data may be 500 KB. When the present channel bandwidth is 1 M/s, then the transmission delay of the first encoded image data is 0.5 s (i.e., 0.5 seconds). If the target transmission delay is 0.25 s, because the transmission delay of the first encoded image data is greater than the target transmission delay, the image frame may be re-encoded to obtain second encoded image data. Before re-encoding the image frame, the UAV may determine an expected transmission delay based on actual needs. For example, if encoding image data of an image frame needs 0.1 s, then the expected transmission delay of the second encoded image data may be set as 0.15 s. This can render the sum of the time spent in re-encoding the image data of the image frame and the transmission delay of the second encoded image data to be not greater than the target transmission delay, thereby satisfying the specified requirement on the transmission delay. Then, the second quantization parameter may be determined based on the expected transmission delay (e.g., 0.15 s) of the second encoded image data. The image frame may be re-encoded using the second quantization parameter. The expected transmission delay of 0.15 s for the second encoded image data is only for illustration purposes. A person having ordinary skill in the art can appreciate that the expected transmission delay may be other values. The present disclosure does not limit the expected transmission delay value.

In some embodiments, encoding image data of an image frame results in first encoded image data. The data rate of the first encoded image data may be 500 KB, and the channel bandwidth of the present communication channel may be 1 M/s. Then the transmission delay of the first encoded image data may be 0.5 s. If the target transmission delay is 0.75 s, because the transmission delay of the first encoded image data is smaller than the target transmission delay, the UAV may re-encode the data of the image frame to obtain second encoded image data. Before re-encoding the data of the image frame, an expected transmission delay for the second encoded image data may be determined based on actual needs. For example, if it takes 0.1 s to encode image data of an image frame, then under the precondition of satisfying the requirement on the transmission delay, the expected transmission delay of the second encoded image data may be determined to be 0.65 s. This can ensure that the sum of the time needed for re-encoding the image data of the image frame and the transmission delay of the second encoded image data is not greater than the target transmission delay, thereby satisfying the requirement on the transmission delay. More details about this situation will be discussed below. Then, a second quantization parameter may be determined based on the expected transmission delay (e.g., 0.65 s) of the second encoded image data. The image data of the image frame may be re-encoded based on the second quantization parameter. The expected transmission delay of the second encoded image data being 0.65 s is only for illustration purposes. A person having ordinary skill in the art can appreciate that the expected transmission delay may be other values. The present disclosure does not limit the expected transmission delay value.

In some embodiments, various methods may be used to determine the second quantization parameter based on the expected transmission delay of the second encoded image data. For example, a corresponding relationship may be established between the expected transmission delay and the quantization parameter. Then the quantization parameter corresponding to an expected transmission delay may be selected as the second quantization parameter.

In some embodiments, an expected data rate of the re-encoded image data may be determined based on the expected transmission delay and the channel bandwidth of the present communication channel. The second quantization parameter may be determined based on the expected data rate.

In some embodiments, encoding image data of an image frame results in first encoded image data. The data rate of the first encoded image data may be 500 KB. The channel bandwidth of the present communication channel may be 1 M/s. Then the transmission delay of the first encoded image data may be 0.5 s. If the target transmission delay is 0.25 s, because the transmission delay of the first encoded image data is greater than the target transmission delay, the image data of the image frame may be re-encoded to obtain second encoded image data. Before re-encoding the image data of the image frame, an expected transmission delay of the second encoded image data may be determined based on actual needs. For example, if it takes 0.1 s to encode image data of an image frame, then the expected transmission delay of the second encoded image data may be 0.15 s. After determining that the expected transmission delay of the second encoded image data is 0.15 s, an expected data rate of the second encoded image data may be determined based on the channel bandwidth of the present communication channel. For example, if the channel bandwidth of the present communication channel is 1 M/s, then the expected data rate may be 150 KB. The second quantization parameter may be determined based on the expected data rate. The image data of the image frame may be re-encoded based on the second quantization parameter to obtain the second encoded image data.

In some embodiments, the transmission delay of the encoded image data may be used to indicate the time needed for transmitting the encoded image data from a transmitting terminal to a receiving terminal. In some embodiments, the transmission delay may also be referred to as a broadcasting delay, i.e., a time period for broadcasting the encoded image data in the communication channel.

The present disclosure does not limit the methods for implementing step 330. As one example of the methods for implementing step 330, the transmission delay of the encoded image data for the present image frame may be estimated based on the transmission delay of the encoded image data for the previous image frame.

In some embodiments, the target transmission delay may be a pre-set requirement on the transmission delay. The target transmission delay may indicate an expected or a pre-set delay requirement on transmitting encoded image data of an image frame. The target transmission delay may be the same or different for different scenes. In other words, the target transmission delay may be used to indicate the delay requirement or delay standard for the present scene. In some embodiments, the target transmission delay may be pre-set by a developer of the image transmission system. In some embodiments, the target transmission delay may be set by a user. Using UAV as an example scene, during the image transmission by the UAV, the target transmission delay Tg may be set as 0.25 s, i.e., the transmission delay of the encoded image data of each image frame is smaller than or equal to 0.25 s. However, under some conditions, even when the transmission delay of the encoded image data is greater than the target transmission delay, the encoded image data may still be directly transmitted. This situation is discussed in detail below.

In some embodiments, as another implementation, step 330 may include: determining the transmission delay of the first encoded image data based on the data rate of the first encoded image data and the channel bandwidth of the present communication channel.

In some embodiments, assuming the data rate of the first encoded image data is R1, the time needed for encoding the image data of an image frame is Te, the channel bandwidth of the present communication channel is B, then the transmission delay of the first encoded image data may be calculated using the following equation: Tt=R1/B, there Tt is the transmission delay of the first encoded image data.

In some embodiments, the communication channel between the transmitting terminal and the receiving terminal may be a wireless communication channel, or a wired communication channel. Various methods may be used to determine the channel bandwidth of a present wireless communication channel. For example, in some embodiments, the transmitting terminal may receive a reference signal from the receiving terminal, and may estimate the channel bandwidth of the present communication channel based on the quality of the reference signal and reciprocity of the communication channel.

In some embodiments, as indicated by step 340, if the transmission delay of the first encoded image data is not within the predetermined range, the image data of the image frame may be re-encoded. The present disclosure does not limit the methods for setting the predetermined range. The predetermined range may be set based on actual needs, which will be described below.

In some embodiments, the predetermined range may be determined based on a target transmission delay for transmitting encoded image data of an image frame and/or time needed for encoding image data of an image frame (e.g., at least one of the transmission delay or the time for encoding the image data).

In some embodiments, the predetermined range may be set based on Tg. For example, when the transmission delay of the encoded image of an image frame is smaller than 0.5 Tg or greater than 1.5 Tg, it may be determined that the transmission delay of the encoded image data is not within the predetermined range.

In some embodiments, the predetermined range may be determined based on the target transmission delay Tg and time Te needed for encoding image data of an image frame. For example, when the transmission delay of the encoded image data of an image frame is greater than Tg+Te, or when the transmission delay of the encoded image data of an image frame is smaller than Tg−Te, it may be determined that the transmission delay is not within the predetermined range, and the image data of the image frame need to be re-encoded.

In some embodiments, various methods may be used to determine the time needed for encoding image data of an image frame. For example, the time spent for encoding (for the first time) the image data of the image frame, as described in step 320, may be used as the time needed for encoding image data of an image frame. As another example, the time spent for encoding the image data of one or more image frames may be recorded. The time needed for encoding image data of the present image frame may be estimated based on the time spent for encoding the image data of the previous one or more image frames.

In some embodiments, the predetermined range may be specified using a first predetermined value and/or a second predetermined value (e.g., at least one of the first predetermined value or the second predetermined value). The first predetermined value and the second predetermined value may be determined based on the target transmission delay for transmitting image data of an image frame and/or the time needed for encoding image data of the image frame. The methods for selecting the predetermined range of step 340 are described in detail below.

In some embodiments, step 340 may include: re-encoding the image data of the image frame in response to determining that the transmission delay of the first encoded image data is greater than or equal to the first predetermined value. The first predetermined value may be determined based on the target transmission delay for transmitting the image data of the image frame and/or the time needed for encoding the image data of the image frame.

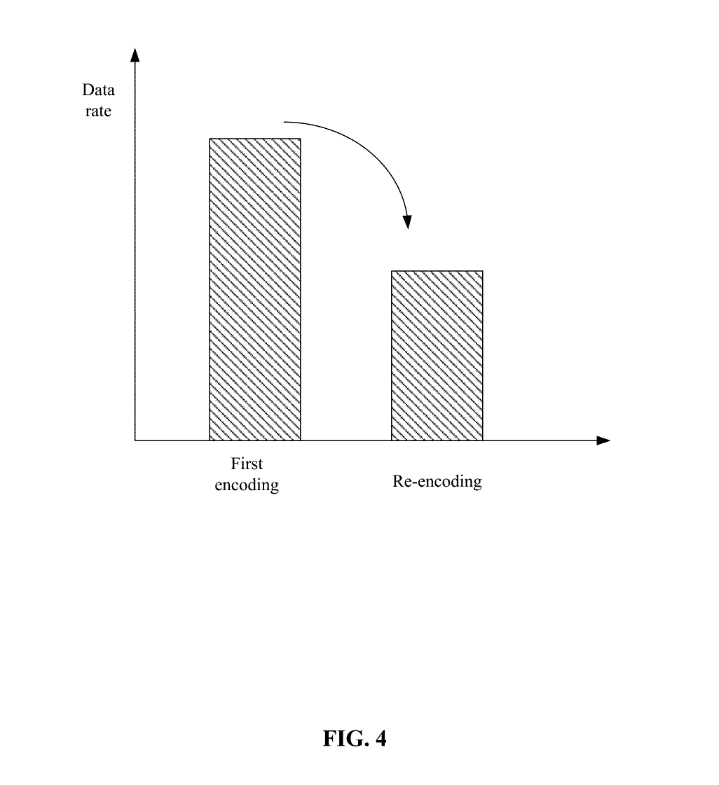

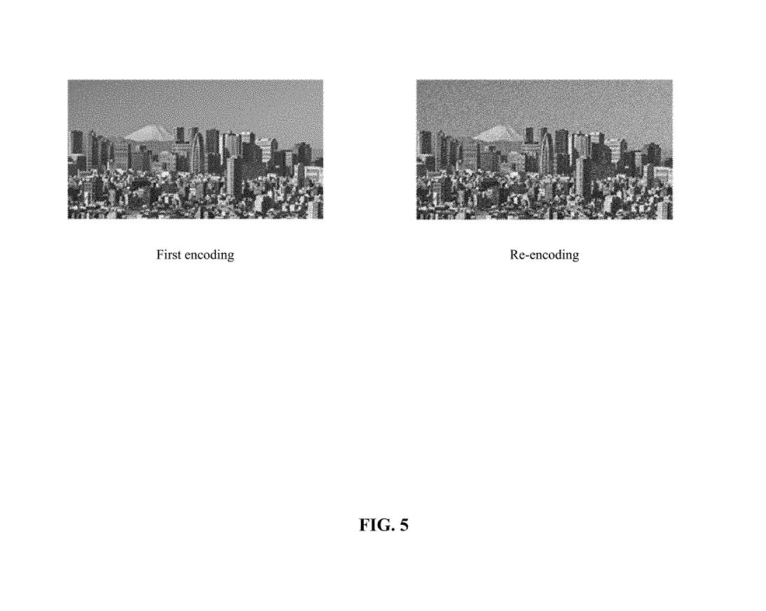

In some embodiments, as one example, the first predetermined value may be 1.3 Tg (Tg being the target transmission delay). When the transmission delay Tt of the first encoded image data determined in step 330 satisfies Tt≥1.3 Tg, the image data may be re-encoded. For example, the transmission delay of the first encoded image data determined in step 330 may be Tt=0.5 s, the target transmission delay may be Tg=0.25 s, then Tt≥1.3 Tg is satisfied. This means if the encoded image data is directly transmitted, the transmission does not satisfy the requirement on the transmission delay under the current scene. Therefore, the image data may be re-encoded to reduce the transmission delay. As shown in FIG. 4, the quantization parameter may be increased, and the re-encoding of the image data may be performed based on the increased quantization parameter, such that the data rate of the re-encoded image data is reduced. In some embodiments, the data rate of the re-encoded image data (i.e., second encoded image data) may be much smaller than the data rate of the first encoded image data. The transmission delay may therefore be reduced. In another example, as shown in FIG. 5, because the data rate of the encoded image data is reduced, the quality of the image may also be reduced. The quality of the image corresponding to the second encoded image data may be much lower than the quality of the image corresponding to the first encoded image data. As a result, the transmission delay for transmitting the second encoded image data may be reduced. This means, the transmission delay of the second encoded image data is reduced by sacrificing the quality of the image. The first predetermined value being 1.3 Tg is only for illustration purposes. A person having ordinary skill in the art can appreciate that the first predetermined value can be other suitable values related to the target transmission delay.

In some embodiments, the first predetermine value may be the sum of the target transmission delay Tg and the time needed for encoding image data of an image frame Te. For example, assuming Tg=0.25 s, Te=0.1 s, if the transmission delay determined in step 330 satisfies Tt>0.35 s, then the image data may be re-encoded. The detailed explanation has been provided in the above descriptions. The first predetermined value being Te+Tg is for illustration purposes only. A person having ordinary skill in the art can appreciate that the first predetermined value can be other suitable values.

In some embodiments, step 340 may include: in response to determining that the transmission delay of the first encoded image data is smaller than or equal to the second predetermined value, re-encode the image data of the image frame. The second predetermined value may be determined based on the target transmission delay associated with transmitting image data of an image frame and/or the time needed for encoding image data of an image frame.

In some embodiments, methods for defining and setting the target transmission delay and the time needed for encoding image data of an image frame have been discussed above.

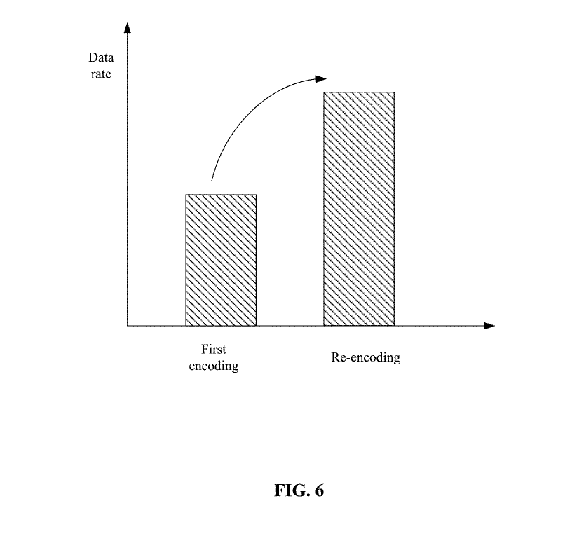

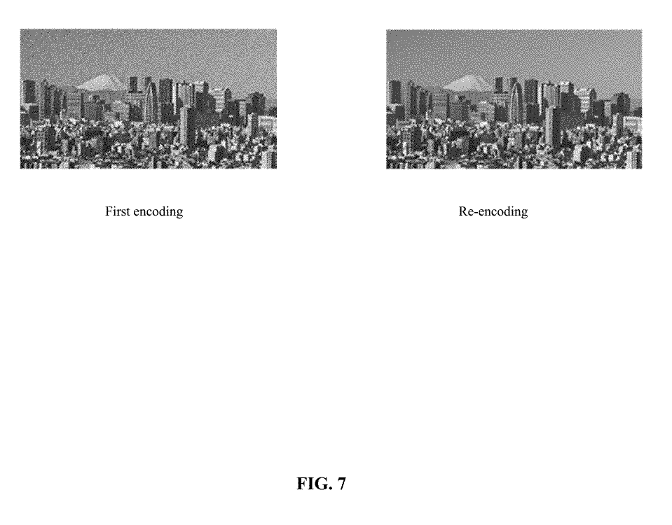

For example, in some embodiments, the second predetermined value may be 0.5 Tg. When the transmission delay of the first encoded image data, as determined in step 330, satisfies Tt≤0.5 Tg, the image data may be re-encoded. The re-encoding may improve the quality of the image while satisfying the requirement on the transmission delay. For example, when Tt=0.1 s, Tg=0.25 s, because Tt is positively proportional to the data rate of the encoded image data, Tt being much less than Tg means the quality of the image may be improved while the requirement on the transmission delay is also satisfied. As shown in FIG. 6, the quantization parameter may be reduced, and the image frame may be re-encoded based on the reduced quantization parameter, such that after the re-encoding, the data rate of second encoded image data is increased. In some embodiments, as shown in FIG. 7, because the data rate is increased after the re-encoding, the quality of the image may be improved. The quality of the image corresponding to the second encoded image data is much better than the quality of the image corresponding to the first encoded image data. Thus, although the transmission delay of the second encoded image data may be increased as compared to that of the first encoded image data, the quality of the image may be improved. The second predetermined value being 0.5 Tg is for illustration purposes only. A person having ordinary skill in the art can appreciate that the second predetermined value may be any other suitable values that are related to the target transmission delay.

In some embodiments, the second predetermined value may be a difference between the target transmission delay Tg and the time Te needed for encoding image data of an image frame. For example, if Tg=0.5 s, Te=0.1 s, and if the transmission delay determined in step 330 is Tt=0.3 s, because Tt≤Tg−Te, the image data may be re-encoded. The re-encoding may increase the data rate of the second encoded image data, improve the quality of the image, while satisfying the requirement on the transmission delay. The second predetermined value being Tg−Te is for illustration purposes only. A person having ordinary skills in the art can appreciate that the second predetermined value can be any other suitable values that are related to the target transmission delay.

In some embodiments, the first predetermined value is the sum of the target transmission delay for transmitting image data of an image frame and the time needed for encoding the image data of the image frame. The detailed explanation has been discussed above.

In some embodiments, the second predetermined value is the difference between the target transmission delay for transmitting image data of an image frame and the time needed for encoding the image data of the image frame. The detailed explanation has been discussed above.

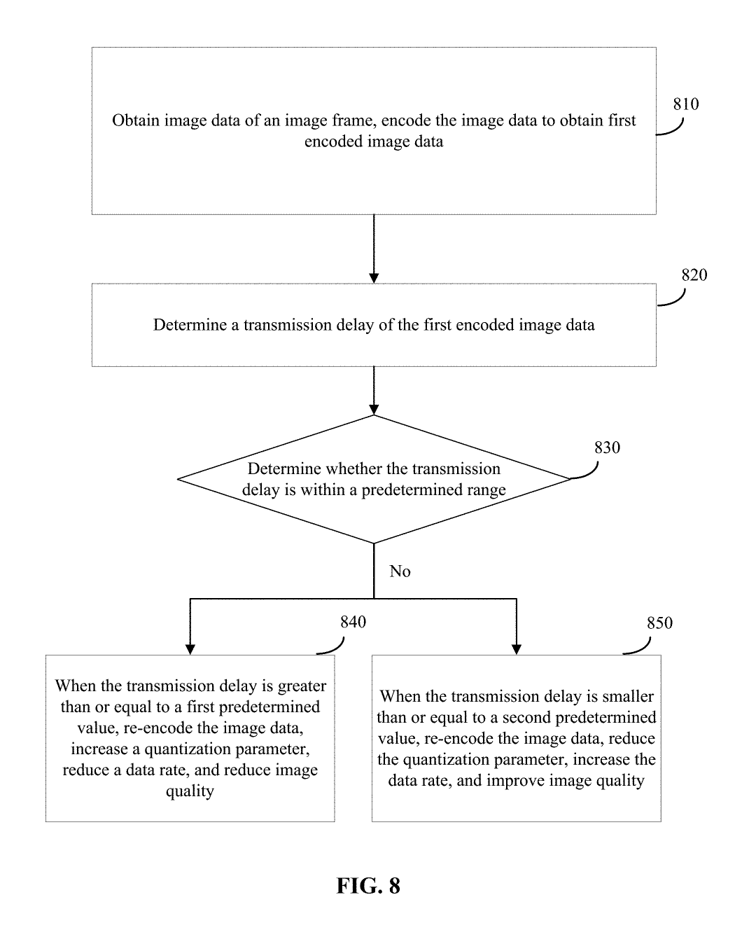

FIG. 8 is a flow chart illustrating a method for image transmission. The method of FIG. 8 may include steps that are similar to certain steps of the method shown in FIG. 3. Descriptions of the similar steps can refer to the above descriptions in connection with FIG. 3. In some embodiments, as shown in FIG. 8, first, the image data are encoded to obtain first encoded image data (step 801). The image data may be encoded to obtain first encoded image data (step 801). Then a transmission delay of the first encoded image data may be determined (step 802). A determination may be made as to whether the transmission delay is within a predetermined range (step 803). When the transmission delay of the first encoded image data is not within a predetermined range (No, step 803), the image data may be re-encoded to obtain the second encoded image data (steps 804 and 805). The re-encoding may render the data rate of the second encoded image data to be different from the data rate of the first encoded image data, thereby achieving adjustments to the encoding of the image data. The re-encoding may make the encoded image data satisfy the requirement on the transmission delay and/or may improve the quality of the image while satisfying the requirement on the transmission delay. For example, when the transmission delay of the first encoded image data is greater than or equal to the first predetermined value, the image data may be re-encoded, the quantization parameter may be increased, the data rate of the second encoded image data may be reduced, and the quality of the image may be reduced (step 804), thereby reducing the transmission delay of the second encoded image data. This means the requirement on the transmission delay of the image transmission may be satisfied by sacrificing the quality of the image. When the transmission delay of the first encoded image data is smaller than or equal to the second predetermined value, the image data may be re-encoded, the quantization parameter may be reduced, the data rate of the second encoded image data may be increased, and the quality of the image may be improved (step 805). The present disclosure may optimize the quality of the image being transmitted while satisfying the requirement on the transmission delay associated with transmitting encoded image data of each image frame.

The above described the methods for dealing with the situation where the transmission delay is not within the predetermined range. In some embodiments, if the transmission delay of the first encoded image data is within the predetermined range, the first encoded image data obtained in step 320 may be directly transmitted.

In some embodiments, when the transmission delay of the first encoded image data is within the predetermined range, it may be determined that the transmission delay of the first encoded image data satisfies the requirement on the transmission delay. The image data need not be re-encoded. The first encoded image data may be transmitted directly. For example, in response to determining that the transmission delay of the first encoded image data is smaller than or equal to the first predetermined value and being greater than or equal to the second predetermined value, the UAV may transmit the first encoded image data. The first predetermined value and the second predetermined value may be determined based on the target transmission delay for transmitting image data of an image frame and/or the time needed for encoding image data of an image frame. The first predetermined value and the second predetermined value have been discussed above.

In some embodiments, although the transmission delay of the first encoded image data is greater than the target transmission delay, the first encoded image data may still be transmitted directly. For example, when Tg<Tt≤Tg+Te, although the transmission delay does not satisfy the target transmission delay, such transmission delay can still satisfy the transmission needs. If the image data are re-encoded, more encoding time and encoding resources may be spent. Therefore, re-encoding may be regarded as unnecessary or not cost-effective. Accordingly, the first encoded image data may be transmitted directly. This can avoid unnecessary encoding processes, and can save encoding resources.

The present disclosure does not limit the methods for processing the second encoded image data obtained in step 340. For example, in some embodiments, the second encoded image data may be transmitted directly, or a determination may be made as to whether the second encoded image data satisfies the requirement on the transmission delay (e.g., whether the transmission delay of the second encoded image data is within the predetermined range) to determine whether to re-encode the image data.

In some embodiments, after step 340, the method of FIG. 3 may further include: calculating the transmission delay of the second encoded image data based on the channel bandwidth of the present communication channel and the data rate of the second encoded image data. The method may also include, in response to determining that the transmission delay of the second encoded image data is not within the predetermined range, re-encoding the image data of the image frame. When re-encoding the image data, the methods for setting the predetermined range and the methods for determining the quantization parameter have been discussed above. In some embodiments, one of the above disclosed methods or a combination of the above disclosed methods may be used to encoding the image data of the image frame multiple times until the transmission delay of the encoded image data is within the predetermined range. The present disclosure does not limit the number of times for encoding the image data, which may be determined based on actual implementation.

The above described methods for setting the predetermined range for the transmission delay. If after step 330, the image data need to be re-encoded, the quantization parameter may be changed, such that the transmission delay of the encoded image data (after being re-encoded) or the quality of the image may be improved. For example, the transmission delay of the re-encoded image data may be within the predetermined range. Further descriptions of such situations are provided below.

In some embodiments, the sum of the transmission delay of the second encoded image data and time needed for encoding the image data of an image frame may be smaller than or equal to the target transmission delay.

For example, the data rate of the first encoded image data may be R1=500 KB, the channel bandwidth of the present communication channel may be B=1 MB/s, the target transmission delay may be Tg=0.25 s. The transmission delay Tt of the first encoded image data may be calculated based on R1 and B to be Tt=0.5 s, more than two times of Tg. Accordingly, the quantization parameter may be increased to reduce the data rate, thereby reducing the transmission delay. However, when re-encoding the image data, time Te needed for encoding the image data of an image frame needs to be considered. If Te=0.1 s, then when re-encoding the image data, the present disclosure may require the transmission delay Tx of the second encoded image data to satisfy Tx+Te≤Tg, i.e., requiring Tx<0.15 s. This may ensure the re-encoding is cost-effective. As such, when the second encoded image data are transmitted, the transmission delay of the second encoded image data may satisfy the requirement on the transmission delay.

In some embodiments, the sum of the transmission delay of the second encoded image data and the time needed for encoding the image data of an image frame may be greater than or equal to a difference between a target transmission delay and the time needed for encoding the image data of an image frame, and may be smaller than or equal to the target transmission delay.

In some embodiments, assuming the target transmission delay is Tg, the time needed for encoding the image data of an image frame is Te, the present disclosure may require the transmission delay Tx of the second encoded image data to satisfy: Tg≥Tx+Te≥Tg−Te. In some embodiments, when Tx is within the specified range, it means the transmission delay of the second encoded image data may satisfy Tg, and the there is no room for further improving the quality of the image (because continuing with re-encoding may consume Te, which may result in an even lower Tx). As such, the disclosed method may optimize the quality of the image, while enabling the transmission delay for transmitting the second encoded image data to satisfy the requirement on the transmission delay. The present disclosure takes into consideration the target transmission delay and the time needed for encoding the image data of an image frame, and controls the transmission delay of the re-encoded image data within a reasonable range, thereby improving the performance of the image transmission system.

In some embodiments, the present disclosure provides a non-transitory computer-readable medium. The computer-readable medium may be configured to store computer program codes or instructions. The computer program codes or instructions, when executed by a processor, cause the processor to perform some or all of the steps of the methods of FIG. 3-FIG. 8.

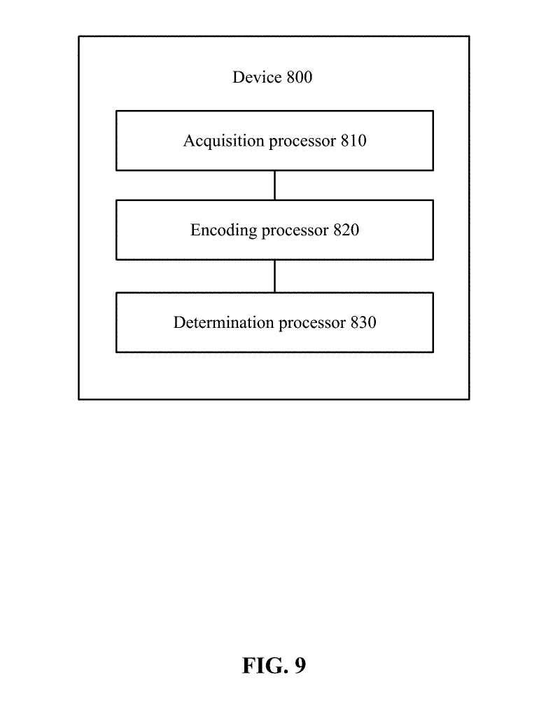

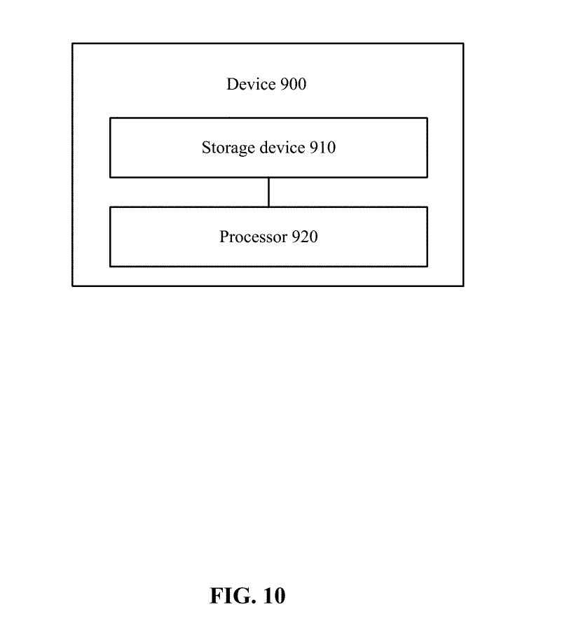

The above described the disclosed methods with reference to FIG. 3-FIG. 8. Next, the disclosed device will be described with reference to FIG. 9-FIG. 10. The disclosed device may be configured to execute the disclosed methods. Thus the detailed descriptions of the functions and/or principles of the disclosed device may refer to the above descriptions of the disclosed methods.

FIG. 9 is a schematic diagram of a device for image transmission. The device 800 may include:

An acquisition processor 810 configured to obtain or acquire image data of an image frame;

An encoding processor 820 configured to encode the image data of the image frame to obtain first encoded image data.

A determination processor 830 configured to determine a transmission delay of the first encoded image data.

In some embodiments, the encoding processor 820 may be configured to re-encode the image data of the image frame to obtain second encoded image data in response to determining that the transmission delay of the first encoded image data is not within a predetermined range.

In some embodiments, the determination processor 830 may determine whether to re-encode image data of the same image frame based on a determination of whether the transmission delay of the first encoded image data is within a predetermined range. In other words, the disclosed device may adaptively determine whether to encode an image frame for one time or for multiple times based on a result of the first encoding of the image data. Accordingly, the disclosed device increases the flexibility of the encoding of the image data at the frame level.

In some embodiments, the predetermine range may be determined based on a target transmission delay for transmitting image data of an image frame and/or the time needed for encoding the image data of an image frame.

In some embodiments, the encoding processor 820 may be configured to encode the image data of an image frame based on a first quantization parameter. The encoding processor 820 may be configured to re-encode the image data of the image frame. Re-encoding the image data may include: determining a second quantization parameter that is different from the first quantization parameter; and re-encoding the image data of the image frame based on the second quantization parameter.

In some embodiments, the determination processor 830 may be configured to determine an expected transmission delay of the second encoded image data. The expected transmission delay may be determined based on the second quantization parameter.

In some embodiments, the determination processor 830 may be configured to determine an expected data rate of the second encoded image data based on the expected transmission delay and a channel bandwidth of the present communication channel. The determination processor 830 may determine the second quantization parameter based on the expected data rate.

In some embodiments, the predetermined range may be specified by a first predetermined value and/or a second predetermined value. The first predetermined value and the second predetermined value may be determined based on a target transmission delay for transmitting image data of an image frame and/or the time needed for encoding the image data.

In some embodiments, the encoding processor 820 may be configured to re-encode the image data of an image frame in response to determining that the transmission delay of the first encoded image data is greater than or equal to the first predetermined value. The first predetermined value may be determined based on the target transmission delay for transmitting the image data of an image frame and/or the time needed for encoding the image data of the image frame.

In some embodiments, the first predetermined value may be a sum of the target transmission delay and the time needed for encoding the image data of the image frame.

In some embodiments, a sum of the transmission delay of the second encoded image data and the time needed for encoding the image data of an image frame is smaller than or equal to the target transmission delay.

In some embodiments, the encoding processor 820 may be configured to re-encode the image data of the image frame in response to determining that the transmission delay of the first encoded image data is smaller than or equal to the second predetermined value. The second predetermined value may be determined based on the target transmission delay for transmitting the image data of the image frame and/or the time needed for encoding the image data.

In some embodiments, the second predetermined value may be the difference between the target transmission delay and the time needed for encoding the image data.

In some embodiments, the sum of the transmission delay of the second encoded image data and the time needed for encoding the image data of the image frame is greater than or equal to the difference between the target transmission delay and the time needed for encoding the image data of the image frame, and the sum is smaller than or equal to the target transmission delay.

In some embodiments, the determination processor 830 may be configured to determine the transmission delay of the first encoded image data based on the data rate of the first encoded image data and the channel bandwidth of the present communication channel.

In some embodiments, the device 800 may include: a transmitter configured to transmit the first encoded image data in response to determining that the transmission delay of the first encoded image data is within the predetermined range.

In some embodiments, the transmitter may be configured to transmit the first encoded image data in response to the transmission delay of the first encoded image data being smaller than or equal to the first predetermined value, and greater than or equal to the second predetermined value. The first predetermined value and the second predetermined value may be determined based on the target transmission delay for transmitting the image data of an image frame and/or the time needed for encoding the image data of the image frame.

FIG. 10 is a schematic diagram of a device for image transmission. Device 900 of FIG. 10 may include a storage device 910 and a processor 920. The storage device 910 may be configured to store computer program codes or instructions. The processor 920 may execute the stored computer program codes or instructions to perform the following steps: obtaining image data of an image frame; encoding the image data of the image frame to obtain first encoded image data; determining a transmission delay of the first encoded image data; re-encoding the image data of the image frame to obtain second encoded image data in response to determining that the transmission delay of the first encoded image data is not within a predetermined range.

In some embodiments, the disclosed device may determine whether to re-encode the image data of an image frame based on a determination of whether the transmission delay of the first encoded image data is within a predetermined range. In other words, the disclosed device 900 may adaptively determine whether to encode the image data of an image frame once or multiple times based on an encoding result of the first encoding, thereby increasing the flexibility of the encoding of the image data at the frame level.

In some embodiments, the predetermined range may be determined based on the target transmission delay for transmitting the image data of an image frame and/or a time needed for encoding the image data of the image frame.

In some embodiments, encoding the image data of an image frame may include: encoding the image data of the image frame based on the first quantization parameter. Re-encoding the image data of the image frame may include: determining a second quantization parameter that is different from the first quantization parameter; and re-encoding the image data of the image frame based on the second quantization parameter.

In some embodiments, determining the second quantization parameter that is different from the first quantization parameter may include: determining an expected transmission delay of the second encoded image data; and determining the second quantization parameter based on the expected transmission delay.

In some embodiments, determining the second quantization parameter based on the expected transmission delay may include: determining an expected data rate of the second encoded image data based on the expected transmission delay and a channel bandwidth of the present communication channel; and determining the second quantization parameter based on the expected data rate.

In some embodiments, the predetermined range may be specified by the first predetermined value and/or the second predetermined value. The first predetermined value and the second predetermined value may be determined based on the target transmission delay for transmitting the image data of an image frame and/or the time needed for encoding the image data of the image frame.

In some embodiments, re-encoding the image data of an image frame in response to determining that the transmission delay of the first encoded image data is not within the predetermined range may include: re-encoding the image data of an image frame in response to determining that the transmission delay of the first encoded image data is greater than or equal to the first predetermined value. The first predetermined value may be determined based on the target transmission delay for transmitting the image data of an image frame and/or the time needed for encoding the image data of an image frame.

In some embodiments, the first predetermined value may be the sum of the target transmission delay and the time needed for encoding the image data of an image frame.

In some embodiments, the sum of the transmission delay of the second encoded image data and the time needed for encoding the image data of an image frame may be smaller than or equal to the target transmission delay.

In some embodiments, re-encoding the image data of an image frame in response to determining that the transmission delay of the first encoded image data is not within the predetermined range may include: re-encoding the image data of the image frame in response to determining that the transmission delay of the first encoded image data is smaller than or equal to the second predetermined value. The second predetermined value may be determined based on the target transmission delay for transmitting the image data of an image frame and/or the time needed for encoding the image data of an image frame.

In some embodiments, the second predetermined value may be the difference between the target transmission delay and the time needed for encoding the image data of an image frame.

In some embodiments, the sum of the transmission delay of the second encoded image data and the time needed for encoding the image data of an image frame is greater than or equal to the difference between the target transmission delay and the time needed for encoding the image data of an image frame, and the sum is smaller than or equal to the target transmission delay.

In some embodiments, determining the transmission delay of the first encoded image data may include: determining the transmission delay of the first encoded image data based on the data rate of the first encoded image data and the channel bandwidth of the present communication channel.

In some embodiments, the processor 920 may be configured to transmit the first encoded image data in response to determining that the transmission delay of the first encoded image data is within the predetermined range.

In some embodiments, transmitting the first encoded image data in response to determining that the transmission delay of the first encoded image data is within the predetermined range may include: transmitting the first encoded image data in response to determining that the transmission delay of the first encoded image data is smaller than or equal to the first predetermined value and greater than or equal to the second predetermined value. The first predetermine value and the second predetermined value may be determined based on the target transmission delay for transmitting the image data of an image frame and/or the time needed for encoding the image data of the image frame.

The present disclosure also provides a UAV, including a propulsion system configured to provide a propulsion force for the flight of the UAV. The UAV may also include an imaging device configured to capture images.

The device 900 shown in FIG. 10 may be configured to transmit the image captured by the imaging device 105.

In some embodiments, the disclosed device may determine whether to re-encode the image data of an image frame based on a determination of whether the transmission delay of the first encoded image data is within a predetermined range. In other words, the disclosed device 900 may adaptively determine whether to encode the image data of an image frame once or multiple times based on an encoding result of the first encoding, thereby increasing the flexibility of the encoding of the image data at the frame level. On one hand, the requirement on the transmission delay associated with transmission of image data is satisfied. On the other hand, the quality of image is improved.

A person having ordinary skill in the art can appreciate that units and algorithms of the disclosed methods and processes may be implemented using electrical hardware, or a combination of electrical hardware and computer software. Whether the implementation is through hardware or software is to be determined based on specific application and design constraints. A person of ordinary skill in the art may use different methods to realize different functions for each specific application. Such implementations fall within the scope of the present disclosure.

A person having ordinary skill in the art can appreciate that descriptions of the functions and operations of the system, device, and unit can refer to the descriptions of the disclosed methods.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using interfaces. The indirect couplings or communication connections between devices or units or components may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated units may be realized using hardware, or may be realized using hardware and software functioning unit.

The disclosed functions may be realized using software functioning units and may be sold or used as an independent product. The software functioning units may be stored in a computer-readable medium as instructions or codes, such as a non-transitory computer-readable storage medium. Thus, the disclosed methods may be realized using software products. The computer software product may be stored in the computer-readable medium in the form of codes or instructions, which are executable by a computing device (e.g., a personal computer, a server, or a network device, etc.) or a processor to perform all or some of the steps of the disclosed methods. The non-transitory computer-readable storage medium can be any medium that can store program codes, for example, a USB disc, a portable hard disk, a read-only memory (“ROM”), a random access memory (“RAM”), a magnetic disk, an optical disk, etc.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method for transmitting images, comprising:
obtaining image data of an image frame;
encoding the image data of the image frame to obtain first encoded image data;
determining a transmission delay of the first encoded image data; and
re-encoding the image data of the image frame to obtain second encoded image data in response to determining that the transmission delay of the first encoded image data is not within a predetermined range.

2. The method of claim 1, wherein the predetermined range is determined based on at least one of a target transmission delay for transmitting the image data of the image frame or a time needed for encoding the image data of the image frame.

3. The method of claim 1, wherein
encoding the image data of the image frame comprises encoding the image data of the image frame based on a first quantization parameter, and
re-encoding the image data of the image frame comprises:
determining a second quantization parameter that is different from the first quantization parameter; and
re-encoding the image data of the image frame based on the second quantization parameter.

4. The method of claim 3, wherein determining the second quantization parameter that is different from the first quantization parameter comprises:
determining an expected transmission delay of the second encoded image data; and
determining the second quantization parameter based on the expected transmission delay.

5. The method of claim 4, wherein determining the second quantization parameter based on the expected transmission delay comprises:
determining an expected data rate of the second encoded image data based on the expected transmission delay and a channel bandwidth of a present communication channel; and
determining the second quantization parameter based on the expected data rate.

6. The method of claim 1, wherein re-encoding the image data of the image frame in response to determining that the transmission delay of the first encoded image data is not within a predetermined range comprises:
re-encoding the image data of the image frame in response to determining that the transmission delay of the first encoded image data is greater than or equal to a first predetermined value,
wherein the first predetermined value is determined based on at least one of a target transmission delay for transmitting the image data of the image frame or a time needed for encoding the image data of the image frame.

7. The method of claim 6, wherein the first predetermined value is a sum of the target transmission delay and the time needed for encoding the image data of the image frame.

8. The method of claim 1, wherein a sum of a transmission delay of the second encoded image data and a time needed for encoding the image data of the image frame is smaller than or equal to a target transmission delay.

9. The method of claim 1, wherein re-encoding the image data of the image frame in response to determining that the transmission delay of the first encoded image data is not within a predetermined range comprises:
re-encoding the image data of the image frame in response to determining that the transmission delay of the first encoded image data is smaller than or equal to a second predetermined value,
wherein the second predetermined value is determined based on at least one of a target transmission delay for transmitting the image data of the image frame or a time needed for encoding the image data of the image frame.

10. The method of claim 9, wherein the second predetermined value is a difference between the target transmission delay and the time needed for encoding the image data of the image frame.

11. The method of claim 1, wherein a sum of a transmission delay of the second encoded image data and a time needed for encoding the image data of the image frame is greater than or equal to a difference between a target transmission delay for transmitting the image data of the image frame and the time needed for encoding the image data of the image frame, and the sum is smaller than or equal to the target transmission delay.

12. The method of claim 1, wherein determining the transmission delay of the first encoded image data comprises:
determining the transmission delay of the first encoded image data based on a data rate of the first encoded image data and a channel bandwidth of a present communication channel.

13. The method of claim 1, further comprising:
transmitting the first encoded image data in response to determining that the transmission delay of the first encoded image data is within the predetermined range.

14. The method of claim 13, wherein transmitting the first encoded image data in response to determining that the transmission delay of the first encoded image data is within the predetermined range comprises:
transmitting the first encoded image data in response to determining that the transmission delay of the first encoded image data is smaller than or equal to a first predetermined value and greater than or equal to a second predetermined value,
wherein the first predetermined value and the second predetermined value are determined based on at least one of a target transmission delay for transmitting the image data of the image frame or a time needed for encoding the image data of the image frame.

15. A device for transmitting images, comprising:
a memory configured to store executable instructions; and
a processor configured to execute the instructions to:
obtain image data of an image frame;
encode the image data of the image frame to obtain first encoded image data;
determine a transmission delay of the first encoded image data; and
re-encode the image data of the image frame to obtain second encoded image data in response to determining that the transmission delay of the first encoded image data is not within a predetermined range.

16. The device of claim 15, wherein the predetermined range is determined based on at least one of a target transmission delay for transmitting the image data of the image frame or a time needed for encoding the image data of the image frame.

17. The device of claim 15, wherein the processor is further configured to:
encode the image data of the image frame by encoding the image data of the image frame based on a first quantization parameter, and
re-encode the image data of the image frame by:
determining a second quantization parameter that is different from the first quantization parameter; and
re-encoding the image data of the image frame based on the second quantization parameter.

18. The device of claim 17, wherein the processor is configured to determine the second quantization parameter that is different from the first quantization parameter by:
determining an expected transmission delay of the second encoded image data; and
determining the second quantization parameter based on the expected transmission delay.

19. The device of claim 18, wherein the processor is configured to determine the second quantization parameter based on the expected transmission delay by:
determining an expected data rate of the second encoded image data based on the expected transmission delay and a channel bandwidth of a present communication channel; and
determining the second quantization parameter based on the expected data rate.

20. The device of claim 15, wherein the processor is configured to re-encode the image data of the image frame in response to determining that the transmission delay of the first encoded image data is not within a predetermined range by:
re-encoding the image data of the image frame in response to determining that the transmission delay of the first encoded image data is greater than or equal to a first predetermined value,
wherein the first predetermined value is determined based on at least one of a target transmission delay for transmitting the image data of the image frame or a time needed for encoding the image data of the image frame.
